(19) United States
(12) Patent Application Publication
(10) Pub. No.: US 2002/0158741 A1
(43) Pub. Date: Oct. 31, 2002

(54) Chip impeder

(76) Inventors: Kunisaburo Tomono, Otsu-shi (JP); Takashi Ohsawa, Shiga-ken (JP); Akihiko Kawakami, Shiga-ken (JP); Mitsuhiro Fukushima, Shiga-ken (JP); Takashi Toda, Kusatsu-shi (JP)

Correspondence Address: KEATING & BENNETT LLP, Suite 312, 10400 Eaton Place, Fairfax, VA, 22030, US

(21) Appl. No.: 10/076,672

(22) Filed: Feb. 19, 2002

(30) Foreign Application Priority Data
Feb. 21, 2001 (JP) 2001-045738

(51) Int. Cl. H01F 5/00

(52) U.S. Cl. 336/200

(57) ABSTRACT

A chip impeder includes a body including a mixture of ferrite powder and a resin. At least one coil electrode is disposed in the body. The ferrite powder and the resin are selected so that the cross point of the impedance in the frequency-impedance characteristic lies in the range of about 1 GHz and higher.

### BACKGROUND OF THE INVENTION

1. Field of the Invention

The present invention relates to a chip impeder which has a sufficient thermal resistance for soldering, and has a greatly improved impedance characteristic in a high frequency band (particularly, in the GHz band) such that the chip impeder can transmit circuit signals in the frequency range of up to several GHz and interrupt high frequency noises with higher frequencies compared to the aforementioned frequency range.

2. Description of the Related Art

Japanese Unexamined Patent Application Publication No. 10-270255, which constitutes related art with respect to the present invention, discloses a high frequency chip bead element having a signal conductor that is spirally embedded inside of an insulating substrate made of a mixture of ferrite powder and an insulating resin. The aforementioned high frequency chip bead element can be produced at a low temperature of 100° C. to 200° C., not at a high temperature (about 900° C.). Thus, the insulating substrate can be easily produced, independent of the firing temperature and the atmosphere for firing.

For the ferrite powder, ferrite materials such as Ni—Cu—Zn, Mn—Zn, Mn—Mg—Zn, Ni—Zn, are used. As the resin having superior characteristics, resins of epoxy, phenol, rubber polyacryl, and polytetrafluoroethylene (Teflon) types are used.

Generally, the frequency-impedance characteristic of such a high frequency chip bead element (chip impeder) as described above can be drawn in a convex curve. In the curve, the impedance rises at the cross point (the frequency at which the values of the real and imaginary portions of the magnetic permeability are equal to each other, in other words, the frequency at which the induction reactance and the resistance are equal to each other, or where the induction reactance and the resistance “cross” each other) and its vicinity.

In recent years, transmission signals having high frequencies (in the GHz band) have been applied in electrical circuits of portable telephones and other electronic apparatuses. Simultaneously, there has been great demand to improve the rise-characteristic of the impedance.

On the other hand, in the case of the above-described high frequency chip bead element described in Japanese Unexamined Patent Application Publication No. 10-270255, the cross point lies in the range of less than 1 GHz. Accordingly, transmission signals having required frequencies are cut off as noises. This causes a problem in that the frequency characteristic of the element is unsatisfactory.

The temperature at which the element is reflow soldered is high. In some cases, the element is modified and damaged by burning or melting. Reflow is a process of forming an external electrode on the high frequency chip bead element. More specifically, the melting point of a non-lead(Pb) solder, which has been widely used in recent years, is higher by 20° C. to 50° C. than that of a Pb-containing solder. This causes the reflow temperature to be higher. For this reason, the heat resistance of the above-described high frequency chip bead element using the resin is unsatisfactory.

Moreover, when polytetrafluoroethylene is used for the high frequency chip bead element, the adhesion to the external electrodes is low, so that high reliability can not be obtained, since the surface free energy is very small.

### SUMMARY OF THE INVENTION

To solve the above-described problems, preferred embodiments of the present invention provide a chip impeder which includes a body having a mixture of ferrite powder and a resin, and at least one coil electrode provided in the body, the cross point of the impedance in the frequency-impedance characteristic being within the range of approximately 1 GHz and greater.

In the above-described preferred embodiment of the present invention, since the body includes the ferrite powder and the resin, the ferrite powder can be shaped by use of the resin, and the firing step can be omitted. Accordingly, the manufacturing of the body having at least one coil electrode is greatly simplified.

Also, in the above-described constitution, since the body includes the ferrite powder and the resin, the dielectric constant of the whole body including the coil electrode is reduced. The stray capacitance, which may be generated between the external electrodes, and between the external electrodes and the coil electrode, is also reduced. As a result, in the above-described constitution, the peak top position of the impedance can be shifted to the high frequency side. This brings about such filter characteristics that signals in a lower frequency band can be transmitted, and signals in a higher frequency range with respect to the lower frequency band can be absorbed.

Moreover, in the above-described constitution, since the cross point of the impedance in the frequency-impedance characteristic is preferably within the range of 1 GHz or higher, transmission signals having required frequencies can avoid being cut off as noises. Thus, the frequency characteristic is greatly improved.

In the chip impeder, preferably, the ferrite includes at least one member selected from the group consisting of hexagonal ferrites (Zn2Y type ferrites, Co2Y type ferrites, and Co2Z type ferrites), Ni ferrites, and NiCo ferrites.

In the above-described preferred embodiment of the present invention, the cross point of the impedance in the frequency-impedance characteristic can be securely and reliably set at approximately 1 GHz or higher, since one of the specific ferrites is used.

In the chip impeder, preferably, the resin includes at least one member selected from the group consisting of polyetheretherketone (PEEK), syndiotactic polystyrene (SPS), polyimide, polybenzoxazine, and polybisallylnadiimide (PBAN).

Since the chip impeder preferably uses the specific resins, the cross point of the impedance in the frequency-impedance characteristic can be securely set at approximately 1 GHz or higher, and moreover, thermal resistance of the chip impeder can be improved. For example, the chip impeder can avoid suffering inconveniences such as modifications by melting or burning, caused by heat at reflow process.

Other features, elements, characteristics and advantages of the present invention will become more apparent from the following detailed description of preferred embodiments thereof with reference to the attached drawings.

### BRIEF DESCRIPTION OF THE DRAWINGS

FIG. 1 is a schematic cross-sectional view of a chip impeder according to a preferred embodiment of the present invention; and

FIG. 2 is a graph showing the impedance characteristics of a chip impeder according to preferred embodiments of the present invention and a chip impeder as a comparative example.

### DETAILED DESCRIPTION OF PREFERRED EMBODIMENTS

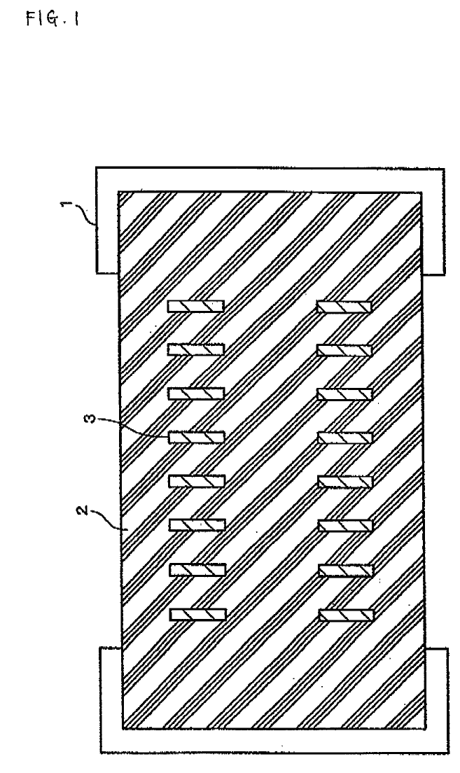

Hereinafter, a chip impeder according to preferred embodiments of the present invention will be described with reference to FIG. 1.

In the chip impeder according to a preferred embodiment of the present invention, as shown in FIG. 1, at least one coil electrode 3 is embedded inside of a body 2 preferably having a hexagonal or columnar shape. The coil electrode 3 is preferably made of a conductive metal such as silver or other suitable material, or is made from a conductive adhesive, has a substantially arc belt shape, and is embedded in such a manner that the center axis of the coil electrode 3 and the axis of the body 2 are substantially parallel to each other. Adjacent arc belt shaped portions of the electrode coil 3 are connected to each other via first through-holes which elongate in the body 2 in the axial direction thereof though this is not shown in the drawing.

External electrodes 1 made of a conductive metal such as silver or other suitable material or made from a conductive adhesive are provided on both sides in the longitudinal direction of the body 2. The coil electrode 3 and each external electrode 1 are connected via second through-holes elongating in the body 2 in the axial direction, though this is not shown in the drawing.

The body 2 preferably includes a mixture of ferrite powder and a resin (polymer). Preferably, the chip impeder is formed by the lamination process described below. First lamination sheets and second lamination sheets described below, contain the mixture of the ferrite powder and the resin, and are laminated in the thickness direction of the sheets in such a manner that adjacent first and second lamination sheets are connected to each other electrically and securely. Thus, the chip impeder according to preferred embodiments of the present invention is produced.

Hereinafter, the lamination process will be described in detail. The first lamination sheets each including the mixture of the ferrite powder and the resin are formed. First through-holes are formed in the lamination sheets. A conductive metal such as silver or other suitable material or a conductive adhesive is applied into each through-hole. Portions of the coil electrode 3 are formed by printing on the first lamination sheets in such a manner that the portion of the coil electrode 3 formed on each first lamination sheet is connected to one end of the first through-hole.

The second lamination sheets, each including the mixture of the ferrite powder and the resin, are formed. Second through-holes are formed in the second lamination sheets, respectively. A conductive metal such as silver or other suitable material or a conductive adhesive is applied in each through-hole. Subsequently, the second lamination sheets are placed on the opposite sides of the overlapped first lamination sheets to sandwich the first lamination sheets in such a manner that conduction between adjacent first and second lamination sheets can be secured. Thus, the chip impeder according to preferred embodiments of the present invention is obtained.

The cross-point in the frequency-impedance characteristic of the above-described chip impeder is set so as to be within the range of 1 GHz and higher by selection of the following ferrite materials and resins.

In the above-described preferred embodiment of the present invention, the body 2 includes the mixture of the ferrite powder and the resin. Accordingly, the ferrite powder can be shaped easily because of the resin. Thus, the step of firing can be omitted. The production of the body 2 provided with at least one coil electrode 3 can be facilitated.

Moreover, in the above-described preferred embodiment of the present invention, the dielectric constant of the whole body 2 including the coil electrode 3 can be reduced, and stray capacities between the external electrodes 1 and between the external electrodes 1 and the coil electrode 3 can be decreased, since the body 2 contains the mixture of the ferrite powder and the resin. As a result, in the above-described preferred embodiment of the present invention, the peak-top position of the impedance can be shifted to the high frequency side. This produces such filter characteristics that signals in a lower frequency band can be transmitted, while signals on the higher frequency side compared to the lower frequency band can be absorbed.

Moreover, in the above-described preferred embodiment of the present invention, the cross point of the impedance in the frequency-impedance characteristic lies in the range of about 1 GHz and higher. Accordingly, the rising of the impedance with respect to the frequency can be set to be steep in the GHz band and its vicinity. Therefore, transmission signals with required frequencies can be prevented from being cut off as noises. Thus, the frequency characteristics of the impeder can be improved.

In general, the impedance Z of the above-described chip impeder is expressed by Z=X+R=ωL₀μ′+ωL₀μ″, in which ω is a frequency, L₀ is the inductance of an air-core coil (L is an inductance), μ′ is the real part of the magnetic permeability, and μ″ is the imaginary part of the magnetic permeability. X=ωL₀μ′ is dominant in the frequency range which is lower compared to the cross point. X increases in proportion to an increment of the frequency. On the other hand, R=ωL₀μ″ is dominant in the frequency range which is higher compared to the cross point.

In the chip impeder of preferred embodiments of the present invention, the cross point lies in the range of about 1 GHz and higher. Therefore, the R component rises after the frequency exceeds the cross point in the GHz band. Thus, the rising of the impedance as a whole becomes steep.

Hereinafter, the specific resin according to the present invention will be described with reference to an example of preferred embodiments of the present invention and a comparative example. Ni—Co ferrite (average particle size of about 1.1 μm) and the respective resins listed in the following Table 1 were mixed at a ratio by volume of 1:1 to prepare the respective mixed materials. Chip impeders were prepared by the above-described laminating process using the aforementioned mixed materials (sample Nos. 1 to 10). The peak frequencies of the impedances of the respective chip impeders are listed in Table 1. The cross points of the respective chip impeders were in the range of about 1 GHz and higher.

Subsequently, the respective chip impeders were dipped in a non-Pb solder bath for approximately 30 seconds, and then, taken out. Each body 2 as a raw member was visually observed at a magnification of 100 by means of a microscope. Table 1 shows the results. The temperature of the solder bath was about 260° C. In Table 1, Ip is an abbreviation of the impedance.

TABLE 1

| | | | Heat | | Peak |
|---|---|---|---|---|---|
| | | | distortion | Appearance | frequency |
| Sample | | Tg | temperature | after dipping | of |
| No. | Resin | (° C.) | (° C.) | in solder | Ip(GHz) |
| 1 | epoxy | 151 | — | discolored | 1.7 |
| 2 | phenol | 155 | — | discolored | 1.4 |
| 3 | ABS rubber | — | <25 | discolored | 1.7 |
| 4 | PAN | — | <100 | discolored | 1.6 |
| 5 | PTFE | — | <100 | discolored | 1.8 |
| 6 | PEEK | — | >300 | not discolored | 1.6 |
| 7 | polyimide | 243 | — | not discolored | 1.7 |
| 8 | SPS | — | 273 | not discolored | 1.6 |
| 9 | PBO | 162 | — | not discolored | 1.6 |
| 10 | PBAN | 212 | — | not discolored | 1.6 |

As shown in Table 1, the appearance of the bodies containing epoxy, phenol, ABS, polyacrylonitrile (PAN), and polytetrafluoroethylene (Teflon, PTFE) selected as the resin was observed after dipping in the solder. Deterioration of the appearance was found. On the other hand, the thermal resistance temperatures of the bodies 2 containing polyetheretherketone (PEEK), polyimide, syndiotactic polystyrene (SPS), polybenzoxazine (PBO), and polybisallylnadiimide (PBAN) were high, and the thermal resistance for soldering were excellent. Thus, the bodies 2 could be sufficiently applied to the non-Pb type high melting point solder.

The results show that as the resin in preferred embodiments of the present invention, thermosetting resins having a glass transition temperature Tg of about 162° C. or higher (Tg≧162° C.) and thermoplastic resins having a heat distortion temperature of about 273° C. or higher (≧273° C.) are preferably used.

Subsequently, a sample No. 11 (the example in the graph) having a cross point at a frequency higher than about 1 GHz, and a sample No. 12 (the comparative example in the graph) having a cross point at a frequency lower than about 1 GHz were prepared, respectively. First, the chip impeder of the sample No. 11 was formed by the lamination process using the mixed material of the Ni—Co—Zn ferrite and the polyimide.

As the comparative example, a chip impeder (sample No. 12) was formed by the lamination process using the mixed material of the Ni—Zn ferrite and the polyimide. In this case, the shape and size of the chip impeder and the number of turns of the coil electrode were the same as those of the sample No. 11.

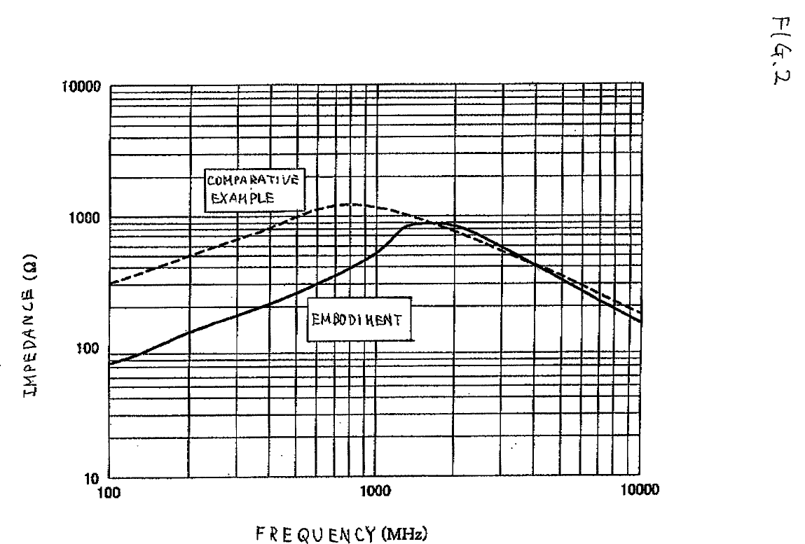

The impedance characteristics of the respective chip impeders were measured using a network analyzer (HP8753D). The chip impeder of the sample No. 11 according to preferred embodiments of the present invention had a cross point at a frequency of about 1.01 GHz. The chip impeder of the sample No. 12 as the comparative example had a cross point at a frequency of 350 MHz. FIG. 2 shows the measurement results of the above-described respective impedance characteristics.

As seen in FIG. 2, when the mixed material of the Ni—Zn ferrite and the polyimide, having a cross point in the frequency-impedance characteristic at a frequency lower than about 1 GHz was used (shown by the broken line in FIG. 2), the rising of the impedance with respect to the frequency was smooth, and the impedance was high in the wide frequency range. Thus, it is understood that required signals in the MHz band are cut off as noises.

On the other hand, when the mixed material including the Ni—Co—Zn ferrite and the polyimide and having a cross point in the frequency-impedance characteristic at a frequency higher than 1 GHz was used (shown by the solid line in FIG. 2), rising of the impedance with respect to the frequency was steep in the GHz band and its vicinity. Thus, it is understood that circuit signals having required frequencies lower compared to the GHz band and its vicinity are not cut off, that is, cutting off of the signals can be suppressed.

In the above-described examples, the mix ratio of the ferrite and a resin was typically set at about 1:1 (ratio by volume). This ratio was not restrictive. Preferably, the mix ratio of the ferrite and a resin is in the range of about 3:7 to about 19:1 (ratio by volume).

In case the amount of the ferrite is less than about 30% by volume, undesirably, the magnetic permeability is decreased, and the impedance becomes lower. On the other hand, in case the amount of the ferrite exceeds about 95% by volume, undesirably, the flow properties of the material are reduced.

According to preferred embodiments of the present invention, the particle size of the ferrite powder is preferably in the range of about 0.05 μm to about 10 μm. In the case of the ferrite powder having a particle size of less than about 0.05 μm being used, undesirably, the specific surface area is increased, so that the flow properties of the material at processing become lower. On the other hand, in case the particle size exceeds about 10 μm, undesirably, the surface of a lamination sheet becomes rugged, and the workability is deteriorated.

Moreover, in preferred embodiments of the present invention, desirably, the ferrite powder in the body 2 is dispersed as evenly as possible, and the resin is interposed between the dispersed particles of the ferrite powder as evenly as possible. For example, in case the uneven distribution of the ferrite particles in the body 2 become remarkable, dispersion of the characteristics of the chip impeder having the body 2 become large in some cases.

The method of mixing the ferrite powder and the resin is not particularly limited. For example, in the case of PEEK or SPS, the ferrite powder and the resin may be kneaded for a short time by means of a kneader or a twin screw extruder in such a manner that the resin is not heat degraded.

As described above, the chip impeder of preferred embodiments of the present invention includes the body having a mixture of ferrite powder and a resin, and at least one coil electrode disposed in the body, wherein the cross point in the frequency-impedance characteristic lies in the range of about 1 GHz and higher.

In the above-described preferred embodiments of the present invention, since the cross point in the frequency-impedance characteristic lies at a frequency of at least about 1 GHz, rising of the impedance in the frequency-impedance characteristic can be set to be steep in the GHz band or its vicinity, and signals having required frequencies which are lower compared to the GHz band and its vicinity can be suppressed from being cut off as noises.

While preferred embodiments of the invention have been described above, it is to be understood that variations and modifications will be apparent to those skilled in the art without departing the scope and spirit of the invention. The scope of the invention, therefore, is to be determined solely by the following claims.

What is claimed is:

1. A chip impeder comprising:
a body including a mixture of ferrite powder and a resin; and
at least one coil electrode provided in the body; wherein
a cross point of the impedance in the frequency-impedance characteristic is within the range of 1 about GHz or greater.

2. A chip impeder according to claim 1, wherein the ferrite comprises at least one member selected from the group consisting of hexagonal ferrites, Zn2Y type ferrites, Co2Y type ferrites, Co2Z type ferrites, Ni ferrites, and NiCo ferrites.

3. A chip impeder according to claim 1, wherein the resin comprises at least one member selected from the group consisting of polyetheretherketone, syndiotactic polystyrene, polyimide, polybenzoxazine, and polybisallylnadiimide.

4. A chip impeder according to claim 1, wherein the body has one of a hexagonal or columnar shape.

5. A chip impeder according to claim 1, wherein the at least one coil electrode is made of one of a conductive metal and a conductive adhesive.

6. A chip impeder according to claim 1, wherein a center axis of the at least one coil electrode and an axis of the body are substantially parallel to each other.

7. A chip impeder according to claim 1, further comprising external electrodes provided on two sides of the body.

8. A chip impeder according to claim 1, wherein the body includes first and second lamination sheets made of the mixture of ferrite powder and resin and being stacked on each other.

9. A chip impeder according to claim 1, wherein the resin is a thermosetting resin having a glass transition temperature Tg of about 162° C. or higher.

10. A chip impeder according to claim 1, wherein the resin is a thermoplastic resin having a heat distortion temperature of about 273° C. or higher.

11. A chip impeder according to claim 1, wherein a particle size of the ferrite powder is preferably in the range of about 0.05 μm to about 10 μm.

12. A method of manufacturing a chip impeder comprising the steps of:
forming a body including a mixture of ferrite powder and a resin; and
disposing at least one coil electrode in the body; wherein
a cross point of the impedance in the frequency-impedance characteristic is within the range of 1 about GHz or greater.

13. The method according to claim 12, wherein the ferrite comprises at least one member selected from the group consisting of hexagonal ferrites, Zn2Y type ferrites, Co2Y type ferrites, Co2Z type ferrites, Ni ferrites, and NiCo ferrites.

14. The method according to claim 12, wherein the resin comprises at least one member selected from the group consisting of polyetheretherketone, syndiotactic polystyrene, polyimide, polybenzoxazine, and polybisallylnadiimide.

15. The method according to claim 12, wherein the body has one of a hexagonal or columnar shape.

16. The method according to claim 12, wherein the at least one coil electrode is made of one of a conductive metal and a conductive adhesive.

17. The method according to claim 12, wherein a center axis of the at least one coil electrode and an axis of the body are substantially parallel to each other.

18. The method according to claim 12, further comprising the step of forming external electrodes on two sides of the body.

19. The method according to claim 12, wherein the step of forming the body includes forming first and second lamination sheets of the mixture of ferrite powder and resin and laminating the first and second lamination sheets on each other.

20. The method according to claim 12, wherein the resin is a thermosetting resin having a glass transition temperature Tg of about 162° C. or higher.

21. The method according to claim 12, wherein the resin is a thermoplastic -resin having a heat distortion temperature of about 273° C. or higher.

22. The method according to claim 12, wherein a particle size of the ferrite powder is preferably in the range of about 0.05 μm to about 10 μm.
